(19) United States
(12) Patent Application Publication
(10) Pub. No.: US 2010/0164986 A1
(43) Pub. Date: Jul. 1, 2010

(54) Dynamic Collage for Visualizing Large Photograph Collections

(75) Inventors: Yichen Wei, Beijing (CN); Yasuyuki Matsushita, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/344,611

(22) Filed: Dec. 29, 2008

(51) Int. Cl. G09G 5/00; G06K 9/00

(52) U.S. Cl. 345/619; 382/118

(57) ABSTRACT

Described is a technology in which a collage of digital photographs is dynamically computed and rendered so as to vary the photographs that are visible in the collage over time. A dynamic collage mechanism coupled to a source of photographs computes a collage for visible output, and dynamically updates the collage on a scheduled basis by adding different photograph(s) in place of other photograph(s). Each arrangement of the photographs in each updated collage is computed from a previous collage. Also described is layout optimization in which the photographs in the updated collage are translated, rotated and/or layered so as to cover a maximum amount of the overall area of the collage.

### BACKGROUND

With the increasing availability of digital cameras and mobile phone cameras, the number of digital photographs that a user may possess may be very large. It is now common to have thousands of family photographs in a personal computer and to browse hundreds of images via an Internet image search.

In general, to visualize photographs, attempts are directed to providing a visually pleasing presentation while retaining efficiency. As the number of photographs increases, the utilization of both screen space and user time becomes an important issue. As a result, visualizing large photograph collections in an efficient and pleasing manner is a great challenge.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a collage of photographs is dynamically computed and rendered so as to vary the photographs that are visible in the collage over time. In one aspect, a dynamic collage mechanism is coupled to a source of photographs to process photographs into a collage. The dynamic collage mechanism computes a collage for visible output, and dynamically updates the collage (e.g., on a scheduled basis) into an updated collage by adding at least one different photograph in place of another photograph or photographs. Each arrangement of the photographs in each updated collage is computed from a previous collage, that is, the new collage is incrementally updated from the previously constructed collage.

In one aspect, the dynamic collage mechanism may include a saliency computation component that ranks or selects photographs to add to the updated collage based upon desired characteristics therein. A scheduling component determines when one photograph is to be added to the updated collage and when another photograph is to be removed from the updated collage.

In one aspect, layout optimization is performed based upon areas of the photographs in the updated collage relative to an overall area of the collage. The photographs in the updated collage (those that were added and those that remain) are translated, rotated and/or layered so as to cover a more optimal amount (e.g., a maximum amount) of the overall area of the collage. Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIGS. 1A and 1B are representations of a collage of images/photographs that are dynamically updated over time.

FIG. 2 is a block diagram showing example components for dynamically updating a collage of images.

FIG. 3 is a representation of a graph model, in which images/photographs are treated as a graph node, with an edge between two nodes when their movable regions overlap.

FIG. 4 shows an illustrative example of a computing environment into which various aspects of the present invention may be incorporated.

### DETAILED DESCRIPTION

Various aspects of the technology described herein are generally directed towards a dynamic approach that continuously updates a photograph collage by inserting new photographs and removing old photographs. The update is done incrementally, providing a smooth temporal transition. To this end, there is described an incremental optimization algorithm, which updates the photograph collage. A large photograph collection can therefore be visualized in a sequential, efficient and pleasing manner. Note that as used herein, a “photograph” comprises any digital image, even if not originally captured by a camera, e.g., a manually generated graphic image.

It should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and image handling in general.

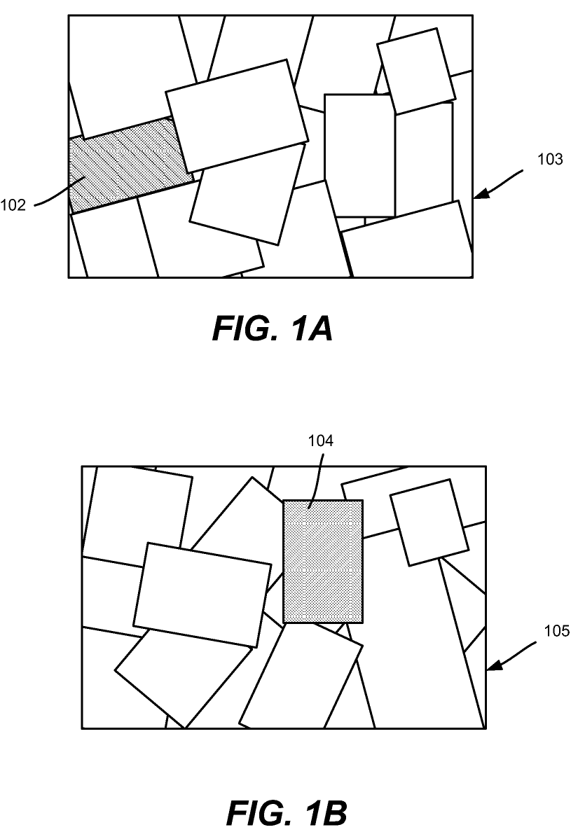

FIGS. 1A and 1B are representations of how a dynamic collage may appear to a user over time, in which each rectangle or partial rectangle represents an image/photograph. Temporal coherency is retained by replacing one or more (typically old) photographs with one or more new ones and updating the photograph arrangement in a local manner. After each photograph insertion/removal, the photographs on the canvas are locally adjusted to maximize the visible visual information. The adjustment is performed in real time with an efficient optimization method.

With respect to changing over time, in this example, the shaded image 102 in the dynamic collage 103 of FIG. 1A is removed and replaced with the shaded image 104 in the dynamic collage 105 of FIG. 1B. As can be readily appreciated, the images may change over time as a whole or independently or in groups relative to one another, e.g., to move over time in any direction, enlarge or contract, rotate and so forth. Further, more than one image may be replaced at the same time.

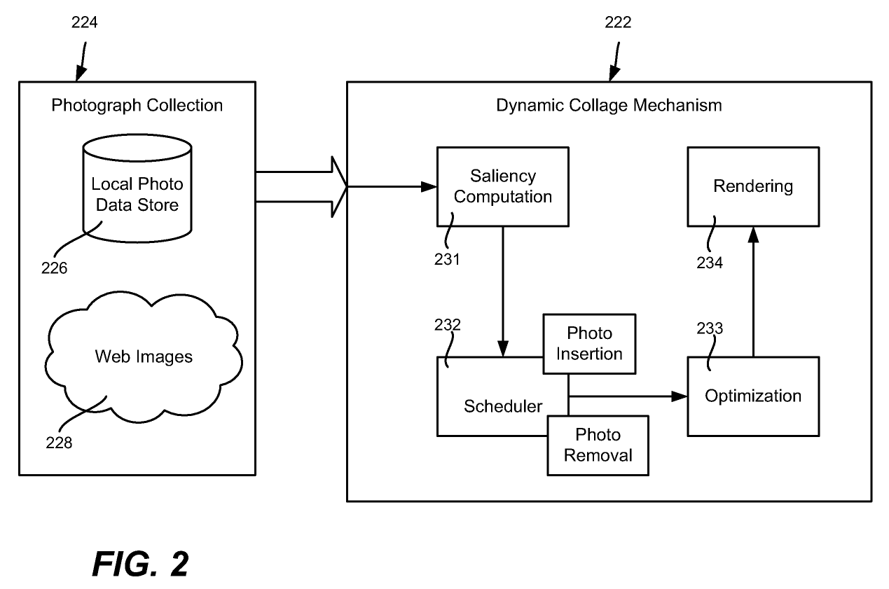

FIG. 2 shows various aspects related to dynamic collage processing. A dynamic collage mechanism 222 takes a collection of photographs as input from a data store 224. The photograph data store 224 can be locally stored data 226, Internet image search results 228, and/or from any source. As will be understood, because processing is performed in a sequential manner, the input photographs do not need to be given to the dynamic collage mechanism 222 at the same time and instead may be passed in a sequential manner; indeed, the input may be a theoretically infinitely long sequence of photographs (such as streaming data).

In one implementation, the dynamic collage system 222 includes four main components, namely a saliency computation component 231, a scheduler component 232 for presentation scheduling, an optimization component 233 and a rendering component 234. Each of these components 231-234 is described in detail below, but in general, these provide an efficient and effective updating algorithm that searches for an optimal solution in real time.

In general, the dynamic collage mechanism 222 takes a large number of photographs and synthesizes a time-varying collage of photograph collections. To this end, the mechanism attempts to compute an optimal arrangement of (a subset of) these photographs in a given size canvas, which is usually much smaller than the total area of the input photographs, such that the composition becomes the best visual summary of the photograph collection. As will be seen, this is a computationally difficult combinatorial optimization problem, and heuristic optimization approaches are typically adopted.

The dynamic collage mechanism 222 achieves temporal continuity and spatial compactness simultaneously during the photograph presentation. For retaining the continuity of the presentation context along the temporal axis, the dynamic collage updates a portion of the collage canvas. Upon the update, one or more photographs are removed and one or more new photographs added to form a new collage, as generally represented in FIGS. 1A and 1B.

The collage canvas is repeatedly updated using the efficient incremental optimization algorithm component 233 that locally re-arranges the locations, poses, and layer orders of photographs. In this way, the dynamic collage process achieves a continuous presentation of large photograph collections as well as efficient and pleasing utilization of screen space.

In FIG. 2, the saliency computation component 231 and scheduler component 232 generally comprise a pre-processing stage prior to the optimization stage performed by the optimization component 233. The saliency computation component 231 analyzes input photographs to determine visually important parts. Note that the photographs that are analyzed may be pre-filtered by another process in advance, e.g., the user may specify that only photographs in a certain folder (c:\kids_pictures), and/or those having certain metadata properties (e.g., scenery) be input to the dynamic collage mechanism 222.

With respect to saliency, note that existing photograph collage methods use a simple ROI (region of interest) -based visual attention model that essentially assigns a uniform importance value inside the rectangular ROI. This has been a limitation as, in practice, one photograph may have more than one ROI, e.g., two faces in a photo, and different ROIs may have different importance data. Unlike this approach, the saliency computation component 231 may use a more general attention model that allows assignment of pixel-wise importance values. To compute the pixel-wise visual saliency, we use a method described in H. Kang, Y. Matsushita, X. Tang, and X. Chen. Space-time video montage. In Proc. of Computer Vision and Pattern Recognition (CVPR), volume 2, pages 1331-1338, 2006. In addition, a known face detector is used with importance values for detected face areas set to infinity to ensure that faces are always visible.

The presentation scheduler component 232 controls the order and timing of inserting and removing photographs to and from the collage, and the timing of performing a desirable layout of the collage during update. Various user definable strategies allow for flexibility of the dynamic collage. For example, each photograph is assigned a lifetime that it is displayed on the canvas. When that photograph's lifetime is over, a “Photograph removal” event is triggered and the photograph is removed from the collage.

After a photograph removal, the ratio of the canvas to the photographs' area increases. When it is above a threshold value (0.75 in one implementation), this indicates there are not enough photographs in the collage. When this occurs, a “Photograph insertion” event is triggered and new photographs are selected to add into the collage so the ratio roughly maintains a constant value (0.65 in one implementation). The lifetimes of different photographs can be the same, e.g., one second, or may be set according to user preferences or different criteria, such as photograph size (a longer time for larger size), richness of content (longer time for more visual information), and so forth.

The selection of new photographs to add into the collage may be ordered in virtually any way, such as based on their time stamps (for an offline photograph collection) or their arrival orders (for online photographs with sequential arrivals). It is also straightforward to provide a user with an interface to specify different rules to control the behavior when more information is available, such as the photograph's metadata/annotation/content. For example, for a family photograph collection, a user may like to see all family members' faces simultaneously on the collage during browsing. Such a requirement can be achieved by creating an initial collage using different people's photographs, and adding new photographs under a rule that adds new photographs of the same people as those removed photographs.

With respect to layout, when adding a new photograph into the collage, its initial positions may be set to the middle of the canvas, or set to match that of a removed photograph. Such behavior also can be controlled when photograph metadata/annotation information is available, e.g., for a family photograph collection, a user may favor the arrangement rule that “father is on the left, mother stays on the right and children are in the middle”. Note that such rules only coarsely specify a favored layout. The layout of the collage is finally computed via the optimization component.

Optimization is performed by the optimization component 233 to update the collage whenever a new photograph is added, or an old photograph is removed (the two events can happen simultaneously from the perspective of the viewer). One implementation uses an incremental optimization algorithm that computes a new collage from the previous one. The optimization process locally adjusts the photographs in the update such that maximal visual information is displayed on the canvas. Additional details of the optimization component 233 are described below.

Once the collage is updated, the rendering component 234 renders a smooth transition from the old photograph arrangement to the new collage by a mathematical process, such as by linear interpolation of each photograph's state, including translation and rotation. Visually, after the optimization stage, the photographs smoothly move to form a new state of collage. The duration of the transition process can be controlled, such as by the user; (a 0.5 second default was used in one implementation).

During photograph removal/insertion, the photographs may be faded in and out instead of suddenly appearing or disappearing. The fading effect is implemented by continuously changing opacity (or the alpha value) of the photograph. The duration of the fading process is also a controllable system parameter (e.g., 0.3 second by default in our system). Alpha-blending may be performed in real time on overlapped regions of photographs to create a seamless visual look. In one implementation, the alpha values are computed proportionally to the pixel's importance values. Note that alpha blending does not necessarily create a better visual look because it blurs photograph boundaries, which some users find undesirable sometimes, whereby alpha blending is an optional visualization method.

Turning to more details of optimization, the dynamic collage optimization attempts to compute a locally optimal arrangement for a set of photographs such that the photographs' states are locally adjusted and maximal visual information is displayed on the canvas. An arrangement of photographs is described by their states which determine how the photographs are positioned on the canvas. In a general form, the relationship between a photograph and the canvas can be described by a similarity transformation that includes translation, scaling, and rotation.

In one implementation of the dynamic collage mechanism, a photograph's parameters include its translation tᵢ=(tᵢ^{x}, tᵢ^{y}) relative to the canvas, and an orientation angle θᵢ. In addition, each photograph is assigned a layer number Iᵢ that determines the order of placement of photographs. The photograph with smaller layer number may be occluded by a photograph with a larger one. Therefore, the parameters of each photograph are represented as xᵢ={tᵢ, θᵢ, Iᵢ}. The optimization problem is then defined as follows: Given N photographs {Iᵢ}ᵢ₋₁^{N}, their importance value maps {Aᵢ}ᵢ₌₁^{N}, and their initial states \hat{X}={\hat{x}ᵢ, i=1, . . . , N}, compute the new states X={xᵢ, i=1, . . . , N} in a local neighborhood of \hat{X} in the state space that maximizes the visible visual information on the canvas, or equivalently, minimizes the occluded visual information:

$$E ( X ) = {\sum }_{i = 1}^{N} {O}_{i} ( X ) , \qquad ( 1 )$$

where the term Oᵢ(X) measures the amount of visual information in photograph i that is occluded by other photographs, or any invisible portion due to being out of the canvas boundary.

Because a photograph may be occluded by any other photographs, the term Oᵢ(X) depends on all photographs' states. The complex form makes the exact computation of occluded information difficult and inefficient in general. This causes a big problem for collage algorithms, as they need to compute this term. In previous work, this is either alleviated by combining a sophisticated computational method with a simple attention model (e.g., each photograph has a single rectangular ROI with constant weight) or is simply neglected by using simple heuristics.

The optimization component 233 described herein solves this problem by a pair-wise approximation. In the dynamic collage, the cost function is simplified so that efficient computation is achieved, and pixel-wise importance maps can be used. It is straightforward to compute an overlapped area of two photographs. The occlusion computation is approximated by a pair-wise computation that takes only two photographs. In this way, the cost function of equation (1) is simplified as:

$$E ( X ) \approx {\sum }_{i = 1}^{N} {B}_{i} ( {x}_{i} ) + {\sum }_{i = 1}^{N} {\sum }_{j = i + 1}^{N} O ( {x}_{i} , {x}_{j} ) \qquad ( 2 )$$

The first term B evaluates the amount of lost information of a photograph due to the out-of-boundary of the canvas. This term only depends on its own parameters (location and rotation). The second term O computes the amount of lost information due to the occlusion of photographs; this is the pair-wise term, as it has dependency two photographs in the approximation. The cost function Eq. (2) becomes exactly the same as Eq. (1) when there are at most two photographs occluding each other. The pair-wise approximation deviates from the exact solution when the same portion of a photograph is occluded by more than one other photograph. In general, when the ratio of the canvas area to the sum of photograph areas is reasonably high (e.g., greater than 0.6), such occlusions only occur at unimportant photograph portions. As a result, the approximation error caused by the pair-wise term stays low, and it makes Eq. (2) a good approximation of Eq. (1) that is efficiently computed.

When the photographs are upright (with no rotation), intersection of two upright rectangles (either a photograph and the canvas for term B, or two photographs for term O) is also a rectangle and can be easily computed. The terms in Eq. (2) represent the importance values in the intersection rectangle on the importance image of a photograph that is outside the canvas (term B) and occluded importance values (term O). The summation of importance values over an arbitrary rectangle can be efficiently computed in a constant time using a known data structure referred to as an integral image.

When the photographs are rotated, as well as the importance images, the intersection of photographs is no longer rectangular and a “brute-force” summation over the intersection area is too slow. This problem is solved by defining a few discrete possible rotation angles and pre-computing more importance images. To this end, for each photograph and an angle, its importance image is rotated accordingly, and a new rectangular importance image is created as the tight bounding box of the rotated one, with the unoccupied area filled with zero values. As a result, the summation over the intersection area of rotated importance images may be efficiently computed using their pre-computed counterparts.

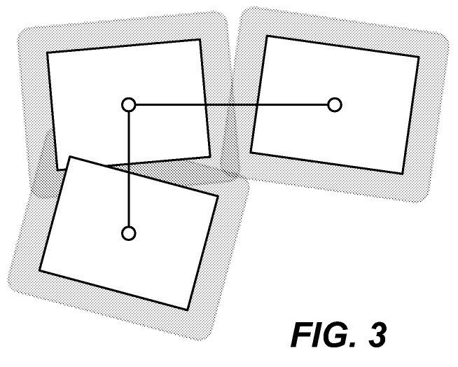

The use of the pair-wise approximation brings significant advantages in the scenario of dynamic collage where each photograph is only allowed to move in a local neighborhood. Once the maximal allowable movement range is known, it can be easily determined which photographs may possibly overlap and which ones do not. As a result, the pair-wise term need not be computed for all possible photograph pairs. This significantly saves computational time, especially when there are many photographs and the local movement range is small. Based on this local movement property and pair-wise approximation, the dynamic collage optimization problem may be conveniently formulated on a graphical model where each photograph is a node and an edge is added between two photographs if they could possibly overlap, given their maximal movement range. FIG. 3 is an example, in which the white rectangles are the images, and the shaded area behind each white rectangle is its moveable range.

Nevertheless, the state space is still large when translation, rotation and layer ordering parameters are considered simultaneously during optimization. To deal with this problem, an alternating optimization approach may be used, in which one parameter is optimized while the other two are fixed.

For optimization of translation in this step, the general problem is to compute optimal translation vectors tis for all photographs with their current rotation angles and layers fixed using the cost function of Eq. (2). Given an initial translation tᵢ, the translation tᵢ of photograph i is allowed to move in a neighborhood. The allowable movement range is defined by

Δ−tᵢ=(Δ−tᵢ^{x}, Δ−tᵢ^{y}) and Δ+tᵢ=(Δ+tᵢ^{x}, Δ+tᵢ^{y}),

where tᵢεR=[\hat{t}ᵢ−Δ−tᵢ, \hat{t}ᵢ+Δ+tᵢ].

The values of Δ−tᵢ and Δ+tᵢ are determined according to the size of blank spaces on the current canvas in the way that those blank areas may be covered when photographs move. Because the largest blank space is often produced by the removal of photograph from the collage, the values of Δ′(−) tᵢ^{x} and Δ+(−) tᵢ^{y} are heuristically set as the width and height of the removed photo. Once the parameters Δ−t and Δ+t are determined, a graph is built by adding edges across nodes. For the optimization, a belief propagation method (the max-product algorithm variation to compute a maximum a posteriori solution) is used, which is a known approximate algorithm to solve inference problems in graphical models. It is proved to generate an optimal solution when the graph contains no loops, but is also shown to generate a good approximate solution when the condition is not met and works well in many computer vision problems. The graph is loopy and it is not ensured to find a stable local minimum. Therefore, the belief propagation is performed for a few iterations and stopped.

In general, belief propagation works by passing messages between connected nodes. The time complexity of each message passing between two nodes is proportional to the total numbers of states that the nodes can take. In this step, the node state is a translation vector. If it is allowed to be at each possible pixel location (with a step size as one pixel) within a range R, the total number of states is too large and message passing is too slow. Thus, a two-level multi-scale strategy is used for speedup. On a coarse scale, belief propagation is run to quickly move photographs to their roughly optimal positions. The translation vector is allowed to take values within the whole range R, but a large step size (or a low resolution of R) is used so there are only a few possible values. On a fine scale, belief propagation is run based on the coarse scale result to locally refine the photo's positions. The translation vector is constrained to move within a small range (the step size used on the coarse scale), but takes values at a small step size (a few pixels).

Turning to optimization of rotation, in this step, each photograph is allowed to change its rotation angle with the translation and layer fixed. As described above, a few pre-defined discrete rotation angles are used (with a step size Δθ, Δθ=5 degrees in one implementation) for efficient computation of the cost function. As in the translation computation step, abrupt angular change is undesirable. Each angle θ is constrained to take one of the five values {\hat{θ}−2Δθ, \hat{θ}−Δθ, \hat{θ}, \hat{θ}+Δθ, \hat{θ}+2Δθ}. Unlike translation, the photograph rotation angle is treated as a variable that aims at increasing visual diversity and enhancing user experience. As too much rotation is undesirable, the rotation angle is constrained to be within [−θₘₐₓ, θₘₐₓ]; (θₘₐₓ=15 degrees in one implementation for aesthetic purposes).

Using the rotation bounds, the graph is updated using the allowed rotation regions in a similar way to that of optimization of translation. Once the graph is updated, the belief propagation algorithm is run to optimize the cost function of Eq. (2). Because the number of states for each node is small (no more than five), this step is computationally inexpensive.

To perform optimization of layers, each photograph is assigned a new layer number with its translation and rotation angle fixed. More specifically, the numbers from 1 to N are identically assigned to all photographs. This step is different from the previous two, in that changes on the layer numbers do not make any change on the current graph structure, and in that it is not straightforward to define distance in the label space because absolute values of layer numbers do not mean much, (only relative orders of overlapping photographs are important). For this reason, direct use of the belief propagation algorithm may not be practical.

To optimize the order of layers, a variant of topological sort algorithm is used. For each edge (i, j) in the current graph, the process computes a direction d of the edge that indicates a favorable layer order between the two photographs i and j, and the amount of information loss e by the layer order. The weight values w(i) and w(j) of photographs i and j are first computed as the sum of importance values in their overlapped area. The direction d is determined as i→j if w(i)<w(j), and j→i otherwise. The direction represents the order of layers. The photograph with a smaller weight w has a smaller label, therefore it is occluded by the other photograph with a larger weight. The information loss e is computed using the amount of visual information that are occluded in the layer order as e=|w(i)−w(j)|.

If the directed graph is acyclic, a topological sort can generate an optimal ordering of all nodes such that the desired edge directions are satisfied. In the standard topological sorting algorithm, a node with no in-edge is always visited before any node that still has in-edges. While the graph is cyclic, instead of trying to visit a node with no in-edge, the process visits a node with the smallest summed weights of in-edges, discards those in-edges and then applies the standard topological sort. In this way, the information loss on those discarded edges is minimized and an ordering of nodes is generated. The layer numbers are then determined accordingly. This step is extremely fast. Optionally, during dynamic collage update, a user may always want to see the new photographs appearing on the top. This can be easily realized by assigning the largest layer number to the latest photograph and removing this photograph from the graph during this step.

In principle, the above three optimization procedures may be performed iteratively, in an alternating manner until the cost function of Eq. (2) no longer decreases. However, optimization of translation on the coarse scale is most effective in decreasing the cost and it also takes the highest computational cost. For this reason, a mixed optimization strategy is used in one implementation, by firstly optimizing the translation parameter on the coarse level. This is done only once to quickly move the photographs at a large step size. Then the process iterates between optimization of translation on the fine scale, and rotation and layer; a suitable number of iterations is three.

In the optimization, the most expensive part is the optimization of translation. The performance depends on the number of possible positions that a translation vector can take. In one implementation, on the coarse scale, the number of steps on both x and y dimension is set as ten, accounting for one hundred total values. On the fine scale, the step size is as five pixels and the number of steps on the x(y) dimension is usually around five. In addition, during belief propagation message passing, the compatibility functions, i.e., the pair-wise terms in Eq. (2), may be pre-computed and buffered in the memory once the importance maps are known. Therefore those terms do not need to be dynamically computed. With these above speedup considerations, the process of translation optimization (summed over all iterations) typically takes about 0.4 seconds (for a 1024×768 canvas and a collage of 20 photographs with Pentium 4, 3 GHz CPU). The rotation optimization is much faster and takes about 0.1 second. The layer optimization is extremely fast and its running cost is negligible. In this way, the dynamic collage achieves real-time performance (about one-half second for the optimization) as opposed to the other techniques.

As can be seen, unlike previous photograph collage techniques that create a static two-dimensional arrangement of photographs, the dynamic collage photograph visualization technique, considers the temporal transition and automatically creates a time-varying photograph collage from a collection of photographs. The output is a spatially compact and temporally smooth representation and is suitable for displaying large photograph collections.

### Exemplary Operating Environment

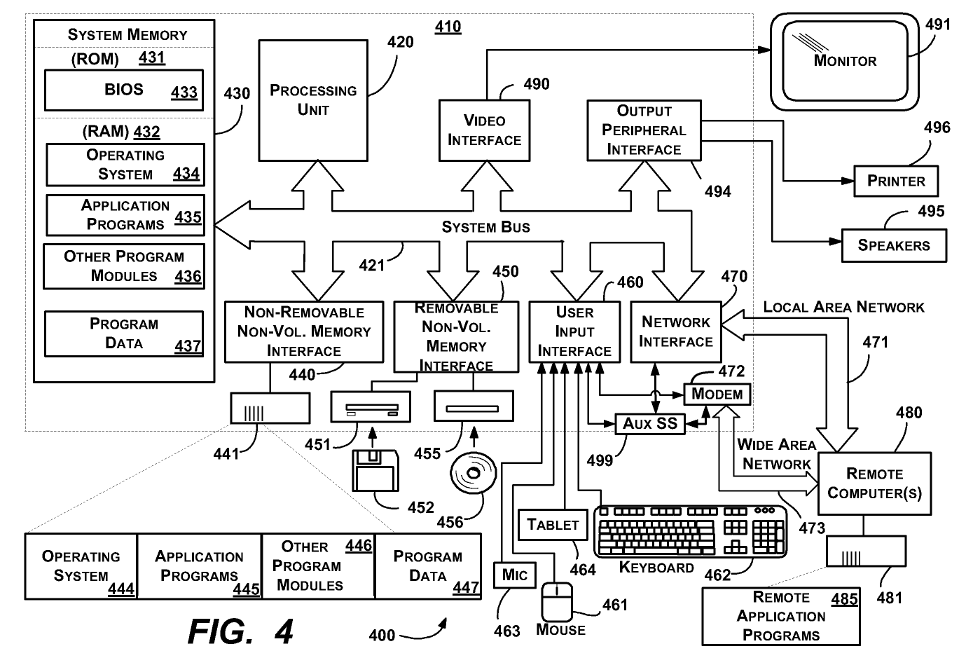

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, inputting a plurality of photographs, arranging the photographs into a collage, dynamically updating the collage by removing at least one photograph, adding at least one other photograph and rearranging the photographs into a collage, and outputting the rearranged collage.

2. The method of claim 1 wherein dynamically updating the collage occurs according to scheduling parameters.

3. The method of claim 2 wherein the scheduling parameters specify a photograph lifetime, a new photograph addition ordering parameter, or a new photograph layout parameter, or any combination of photograph lifetime, a new photograph addition ordering parameter, or a new photograph layout parameter comprises

4. The method of claim 1 further comprising, selecting photographs for the collage based on saliency computations.

5. The method of claim wherein selecting photographs for the collage based on saliency computations comprises performing face detection or using pixel importance data, or both performing face detection and using pixel importance data.

6. The method of claim 1 further comprising, rendering the collage including fading effects, alpha blending, or both fading effects and alpha blending.

7. The method of claim 1 wherein rearranging the photographs comprises computing a new arrangement based upon a previous arrangement, including performing an optimization that is based on area of the added photograph or photographs, area of the removed photograph or photographs, and an area of a collage canvas.

8. The method of claim 7 wherein computing the new arrangement based upon an optimization includes varying translation parameters, varying rotation parameters, or varying layer parameters associated with the photographs, or any combination of varying translation parameters, varying rotation parameters, or varying layer parameters.

9. The method of claim 7 wherein computing the new arrangement based upon an optimization includes varying translation parameters, including performing a coarse-grained translation of the photographs with respect to their positions in a collage canvas area, before performing a fine-grained translation of the photographs with respect to their positions in the collage canvas area.

10. The method of claim 7 wherein computing the new arrangement based upon an optimization includes varying at least one translation parameter while at least one rotation parameter and at least one layer parameter are fixed, varying at least one rotation parameter while at least one translation parameter and at least one layer parameter are fixed, and varying at least one layer parameter while at least one translation parameter and at least one rotation parameter are fixed.

11. In a computing environment, a system comprising, a dynamic collage mechanism coupled to a source of photographs, the dynamic collage mechanism computing a collage for visible output, dynamically updating the collage into updated collages by adding different photographs in place of other photographs over time, in which each arrangement of the photographs in each updated collage is computed from a previous collage.

12. The system of claim 11 wherein the dynamic collage mechanism includes a saliency component that ranks or selects photographs to add to the updated collage based upon desired characteristics therein.

13. The system of claim 11 wherein the dynamic collage mechanism includes a scheduling component that determines when one photograph is to be added to the updated collage and when another photograph is to be removed from the updated collage.

14. The system of claim 11 wherein the source of the photographs comprises a local store, a stream of photographs, or image search results, or any combination of a local store, a stream of photographs, or image search results.

15. The system of claim 11 wherein the dynamic collage mechanism includes an optimization component that computes the updated collage from the previous collage by computing areas of the photographs in the updated collage relative to an area of the collage, and translating, rotating and/or layering at least some images to cover a more optimal amount of the area of the collage.

16. One or more computer-readable media having computer-executable instructions, which when executed perform steps, comprising:
(a) outputting a currently constructed collage for rendering;
(b) computing an updated collage by removing at least one photograph from data corresponding to the currently constructed collage and adding at least one other photograph to the data corresponding to the currently constructed collage; and
(c) setting the currently constructed collage to be the updated collage and returning to step (a).

17. The one or more computer-readable media of claim 16 having further computer-executable instructions comprising selecting each photograph to add to the updated collage based upon saliency processing.

18. The one or more computer-readable media of claim 16 wherein computing the updated collage comprises operating in response to a schedule.

19. The one or more computer-readable media of claim 16 wherein computing the updated collage comprises determine areas of the photographs in the updated collage relative to an area of the collage, and translating, rotating and/or layering at least some images to cover a more optimal amount of the area of the collage.

20. The one or more computer-readable media of claim 16 having further computer-executable instructions comprising rendering the currently constructed collage, including performing fading effects, alpha blending, or both fading effects and alpha blending with respect to a previous rendering.
